(19) United States
(12) Patent Application Publication
(10) Pub. No.: US 2012/0180761 A1
(43) Pub. Date: Jul. 19, 2012

(54) HIGH-PRESSURE UNIT FUEL INJECTOR

(75) Inventors: Shriprasad Gaurishankar Lakhapati, Glendale Heights, IL (US); Biao Lu, Manchester, CT (US); Dean Alan Oppermann, Plainfield, IL (US); Russell P. Zukouski, Bolingbrook, IL (US); Erik Jordan Hansen, Westmont, IL (US)

(73) Assignee: International Engine Intellectual Property Company, Lisle, IL (US)

(21) Appl. No.: 13/497,049

(22) PCT Filed: Sep. 13, 2010
(86) PCT No.: PCT/US10/48581

§ 371 Date: Mar. 19, 2012

Related U.S. Application Data
(60) Provisional application No. 61/243,238, filed on Sep. 17, 2009.

(51) Int. Cl. F02M 69/04

(52) U.S. Cl. 123/445

(57) ABSTRACT

A check valve body (44) is disposed within the interior of a main body (32) of a fuel injector (30) and contains a continuous sealing ridge for sealing a perimeter of a cavity (124) between the proximal end face of the check valve body and the distal end face of an intensifier cartridge body (46). A spring cage (42) has a proximal end face disposed within the interior of the main body. An entry check (154) is disposed in an entry through-passage (132), and an exit check (156) is disposed in an exit through-passage (130). A continuous sealing ridge seals a perimeter of an exit cavity (140), and a discontinuous sealing ridge seals a portion of a perimeter of an entry cavity (144). The sealing ridges are asymmetric about a longitudinal axis AX.

### TECHNICAL FIELD

This disclosure relates generally to internal combustion engines having cylinders into which fuel is injected, and more particularly to a unit injector for direct high-pressure injection of diesel fuel into an engine cylinder.

### BACKGROUND OF THE DISCLOSURE

A known electronic engine control system comprises a processor-based engine controller that processes data from various sources to develop control data for controlling certain functions of the engine, including fueling of the engine by unit fuel injectors that inject fuel directly into engine cylinders. One type of unit fuel injector is commonly known as a HEUI injector, the four-letter acronym standing for hydraulically-actuated, electrically-controlled unit injector.

A HEUI injector has a fuel inlet port communicated to a source of fuel under pressure, such as pressurized fuel in a fuel rail. It also has an oil inlet port communicated to a source of hydraulic fluid under pressure, such as pressurized oil in an oil rail. Fuel is injected out of the injector through orifices in a nozzle having a tip end disposed within the head end of an engine cylinder.

Injection of fuel is controlled by an electric actuator that when actuated opens a valve that allows oil from the oil rail to pass through the oil inlet port and apply hydraulic force to a piston that is disposed at one end of a plunger. The piston transmits the hydraulic force to the plunger which then applies the force to fuel that the pressure in the fuel rail has forced into the fuel injector. The hydraulic force creates additional and much greater pressure (intensified pressure) that acts on certain movable elements within the fuel injector.

One such movable element is a fuel inlet check that allows fuel from the fuel rail to enter the injector through the fuel inlet port when the actuator is not actuated, but that is forced to close the fuel inlet port when the actuator is actuated, thereby trapping fuel that has entered the injector so that the fuel does not backflow through the fuel inlet port, but instead can be injected out of the nozzle orifices as the hydraulic force causes the plunger to extend.

Another movable element is a reverse flow check that, when the actuator is not being actuated and a return spring is forcing the plunger to retract, substantially closes a fuel path from the plunger to the nozzle in order to avoid sudden large pressure drop in the portion of that fuel path between the nozzle and the reverse flow check. The retracting plunger allows the fuel rail pressure to open the fuel inlet check to replenish the fuel in the injector as the plunger retracts.

With fuel having been replenished, the next actuation of the actuator causes the plunger to once again increase pressure on fuel and force the fuel inlet check closed to prevent backflow of fuel from the injector into the fuel rail, while forcing the reverse flow check to open the fuel path to the nozzle. The intensified fuel pressure unseats a spring-biased needle from an internal seat in the nozzle. The unseating of the needle against the opposing spring bias opens the fuel path from the plunger to the nozzle orifices to allow fuel to be injected into an engine cylinder as the plunger extends. When the actuator ceases being actuated, the intensified pressure that was being applied by the plunger terminates, allowing the bias spring to re-seat the needle and thereby terminate injection.

Control of injection encompasses control of both the duration of an injection of fuel and the timing of the injection so that the control system thereby controls quantity of fuel injection and when fuel is injected during an engine cycle.

### SUMMARY OF THE DISCLOSURE

The ability of a fuel injector to inject fuel at very high pressures can have favorable implications for quality of combustion and engine performance. Higher pressures create larger stresses in component parts and those stresses are amplified even more at stress concentration points. The cyclical nature of such stresses and the sheer number of injection cycles that a fuel injector will typically perform may eventually tax component parts, even those made of extremely strong materials, to failure at stress concentration points. Because increased pressure also increases forces that act to separate component parts, internal leakage is more apt to occur.

The ability of a fuel injector to inject fuel at increasingly higher pressures can have favorable implications for quality of combustion and engine performance. Higher pressures however create larger stresses in component parts, and those stresses are amplified even more at stress concentration points. The cyclical nature of such stresses and the sheer number of injection cycles that a fuel injector will typically perform may eventually tax component parts, even those made of extremely strong materials, to failure at stress concentration points. Because increased pressure also increases forces that act to separate component parts, internal leakage is more apt to occur.

The present disclosure relates to a construction for enabling a fuel injector to reliably operate consistent with its design intent at very high injection pressures throughout its expected useful life. The illustrated construction comprises a single check valve body sealed proximally to the body of an injector cartridge and sealed distally to a spring cage. The check valve body comprises distinctive sealing ridge patterns that create sealed cavities in its proximal and distal end faces. The cavities have features that mitigate stress concentrations thereby enabling the fuel injector to operate at higher injection pressures.

One generic aspect of the present disclosure relates to a unit injector comprising a main body circumferentially surrounding an imaginary longitudinal axis and having an interior that is open at a proximal end a fuel inlet in the main body through which fuel can enter the interior of the main body.

An intensifier cartridge comprises a cartridge body that closes the open proximal end of the main body and has a distal end face disposed within the interior of the main body.

A check valve body is disposed within the interior of the main body and comprises a proximal end face that confronts the distal end face of the cartridge body.

A continuous sealing ridge seals a perimeter of a cavity between the proximal end face of the check valve body and the distal end face of the cartridge body.

An additional body (a spring cage in the illustrated embodiment) comprises a proximal end face that is disposed within the interior of the main body and confronts a distal end face of the check valve body.

An entry check is disposed in an entry through-passage in the check valve body, and an exit check is disposed in an exit through-passage in the check valve body.

A continuous sealing ridge seals a perimeter of an exit cavity which is between the proximal end face of the additional body and the distal end face of the check valve body, and to which the exit through-passage is open.

A discontinuous sealing ridge seals a portion of a perimeter of an entry cavity which is between the proximal end face of the additional body and the distal end face of the check valve body, and to which both the fuel inlet port and the entry through-passage are open.

A fuel passage from the fuel exit cavity extends through the additional body and leads to orifices from which fuel is injected from the injector.

The cartridge body comprises a bore having a distal end open to the cavity between the distal end face of the cartridge body and the proximal end face of the check valve body, and a plunger that is displaceable axially within the cartridge body bore.

A mechanism displaces the plunger proximally and distally within the cartridge body bore.

The plunger, when displaced proximally, is effective to unseat the entry check and draw fuel from the interior of the main body, through the entry through-passage, through the cavity between the distal end face of the cartridge body and the proximal end face of the check valve body, and into the cartridge body bore while forcing the exit check to substantially close the exit through-passage, and when displaced distally, is effective to force the entry check to close the entry through-passage, to force the exit check out of substantial closure of the exit through-passage, and to force fuel from the cartridge body bore, through the cavity between the distal end face of the cartridge body and the proximal end face of the check valve body, through the exit through-passage, through the exit cavity, and through the fuel passage from the exit cavity through the additional body.

The foregoing summary, accompanied by further detail of the disclosure, will be presented in the Detailed Description below with reference to the following drawings that are part of this disclosure.

### BRIEF DESCRIPTION OF THE DRAWINGS

FIG. 1 is an elevation view of a fuel injector partly in cross section.

FIG. 2 is an enlarged view of a distal portion of the fuel injector of FIG. 1.

FIG. 3 is an enlarged view of a portion of FIG. 2.

FIG. 4 is an enlarged view of a portion of FIG. 3.

FIG. 5 is a cross section view showing one of the parts of FIGS. 1-4 by itself.

FIG. 6 is a full top view of FIG. 5.

FIG. 7 is an enlarged view of one portion of the part shown in FIG. 5.

FIG. 8 is an enlarged view of another portion of the part shown in FIG. 5.

FIG. 9 is a view showing another of the parts of FIGS. 1-4 by itself

FIG. 10 is a top view of FIG. 9.

FIG. 11 is an enlarged cross section in the direction of arrows 11-11 in FIG. 9.

FIG. 12 is an enlarged view, partly in cross section, of a portion of the fuel injector of FIG. 1.

FIG. 13 is cross section view showing some of the same parts shown in FIG. 12, but looking in a direction indicated by arrows 13-13 in FIG. 14.

FIG. 14 is a full top view of one of the parts in FIGS. 12 and 13 shown by itself.

FIG. 15 is a cross section view in the direction of arrows 15-15 in FIG. 14.

FIG. 16 is a cross section view in the direction of arrows 16-16 in FIG. 14.

FIG. 17 is a full bottom view of the part shown in FIG. 14.

FIG. 18 is a perspective view of the bottom of the part shown in FIG. 14.

FIG. 19 is a perspective view of the top of the part shown in FIG. 14.

FIG. 20 is a top plan view of another of the parts in FIG. 12 shown by itself.

FIG. 21 is a cross section view in the direction of arrows 21-21 in FIG. 20.

FIG. 22 is a somewhat enlarged perspective view of the top of the part shown in FIG. 20 looking from the side.

### DETAILED DESCRIPTION

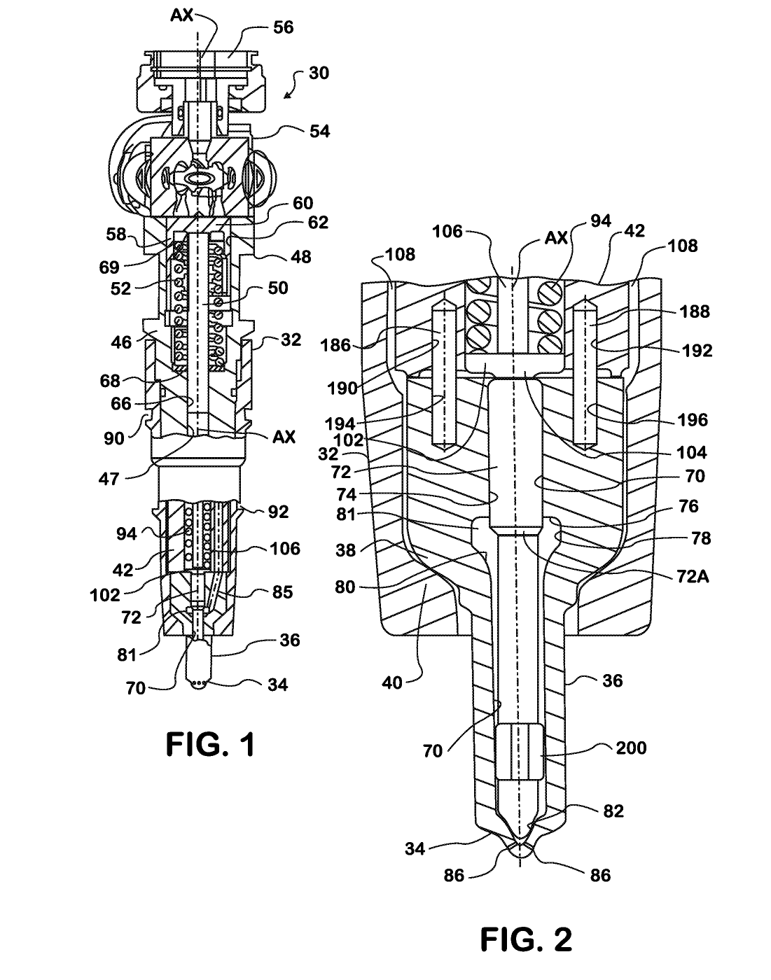

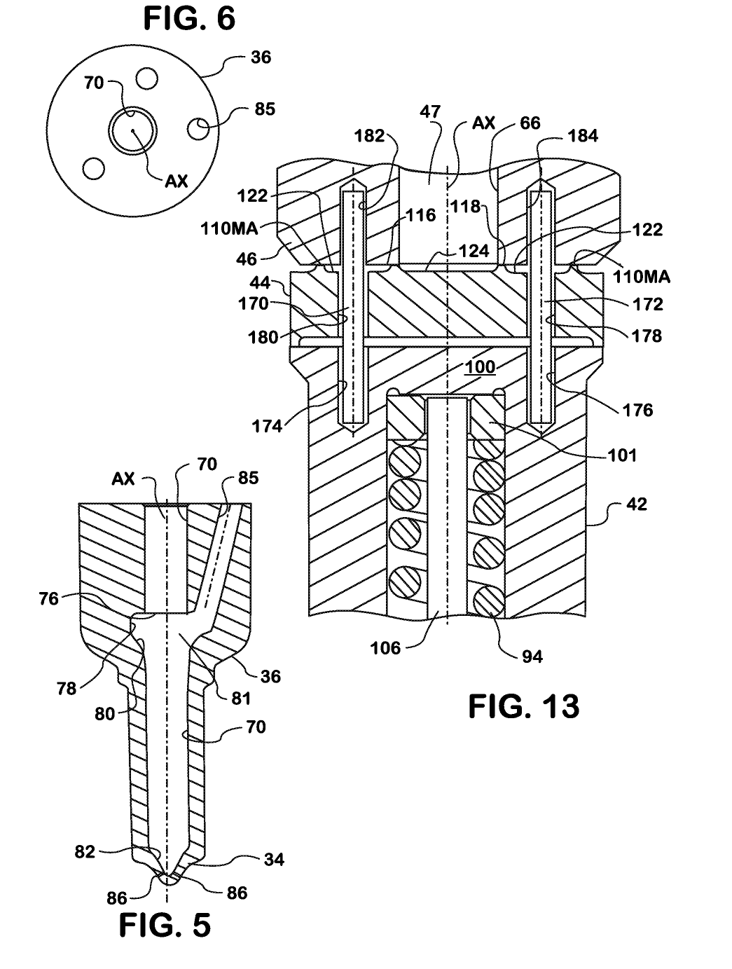

FIG. 1 shows a fuel injector 30 comprising a generally cylindrical main body 32 that mounts on a cylinder head of an engine (not shown) to dispose a tip end 34 of a nozzle 36 (also shown in FIGS. 2 through 8) in the head end of a cylinder bore (not shown) within which a piston coupled by a piston rod to a crankshaft reciprocates. Fuel injector 30 is intended for use with a diesel engine to inject diesel fuel directly into the cylinder where the fuel combusts in air that has been compressed by the piston to create pressure that forces the piston to downstroke and impart torque to the crankshaft through the piston rod.

Main body 32 has an imaginary longitudinal axis AX and an interior that is open at both a proximal end of axis AX and a distal end of axis AX. A larger diameter portion of nozzle 36 is disposed within the interior of main body 32 to close the main body's open distal end by abutment of an outer shoulder 38 of nozzle 36 with an inner shoulder 40 of main body 32 (see FIG. 2) while a smaller diameter portion of nozzle 36 that includes tip end 34 protrudes distally out of main body 32. The larger diameter portion of nozzle 36 comprises a flat proximal end face against which a distal end face of a spring cage 42 is disposed.

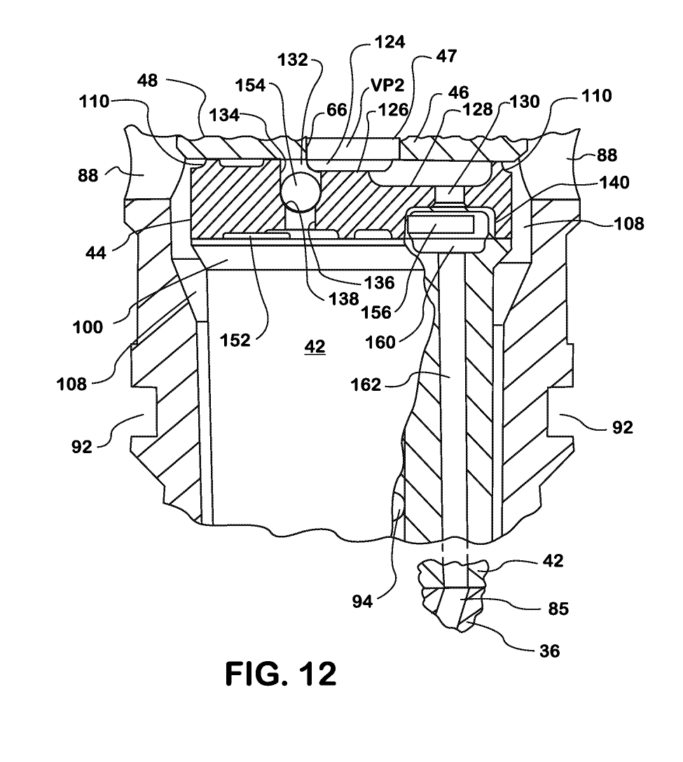

Fuel injector 30 further comprises a circular check valve body 44, shown in FIGS. 12 through 19, that is disposed within the interior of main body 32 concentric with axis AX and an intensifier cartridge 48 (FIGS. 1 and 12) that closes the open proximal end of main body 32. As particularly shown in FIGS. 12 and 13, a distal end face of check valve body 44 contains a sealing ridge geometry (to be described in detail later) that is disposed against a flat proximal end face of spring cage 42. As shown in FIG. 1, intensifier cartridge 48 comprises a generally cylindrical cartridge body 46, and as shown in FIG. 12, cartridge body 46 has a flat distal end face that is disposed within the interior of main body 32 against a proximal end face of check valve body 44 that also contains a sealing ridge geometry to be described in detail later. Cartridge body 46 comprises a bore 47 that is coaxial with axis AX and open at both proximal and distal ends of body 46. Intensifier cartridge 48 further comprises a piston 58, a plunger 50 and a return spring 52 that acts to bias piston 58 and plunger 50 proximally of axis AX.

Mounted at a proximal end of cartridge body 46 is an electric-actuated valve 54 that has an outlet port open to a proximal end face of piston 58 and an inlet port 56 that is communicated to oil under pressure in an oil rail (not shown) when fuel injector 30 is installed on an engine.

Piston 58 comprises a circular head 60 that contains the piston's proximal end face to which the outlet port of valve 54 is open. Piston 58 also has a skirt extending distally from head 60 and providing a close sliding fit for the piston within a larger diameter circular bore portion 62 of bore 47 that is open to the proximal end of cartridge body 46.

Plunger 50 has a smaller diameter than piston 58 and extends distally of the interior of head 60 with a close sliding fit to a smaller diameter circular bore portion 66 of bore 47.

A shoulder 68 at the junction of larger diameter circular bore portion 62 and smaller diameter circular bore portion 66 provides support for a bearing at the distal end of return spring 52. The proximal end of return spring 52 bears against a head 69 of plunger 50 that in turn bears against piston head 60 without plunger head 69 attaching to piston head 60.

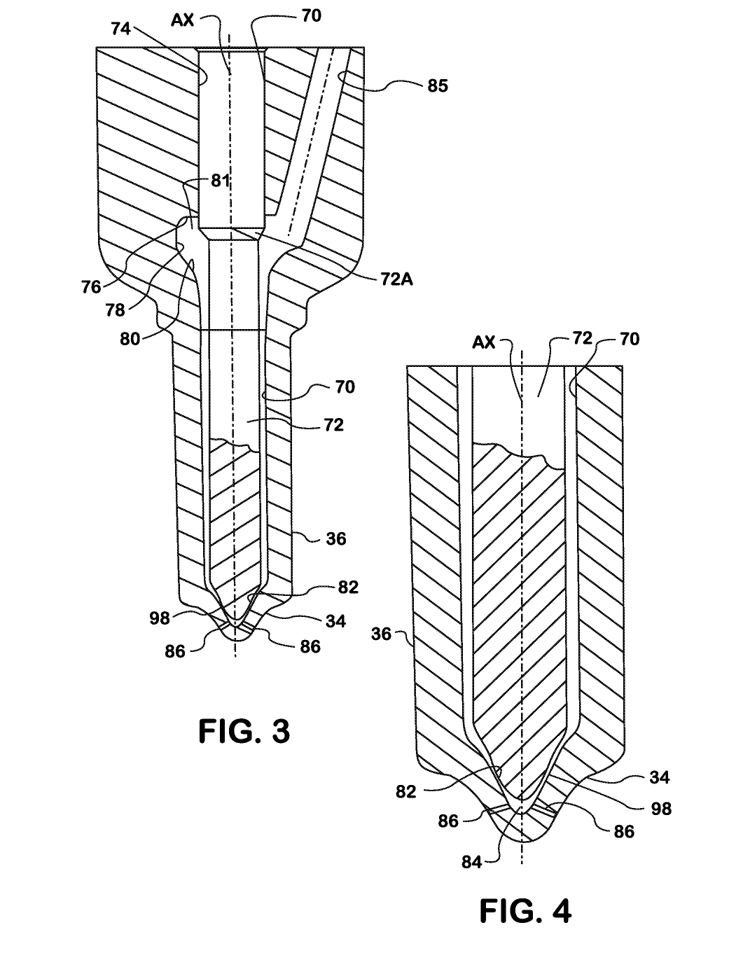

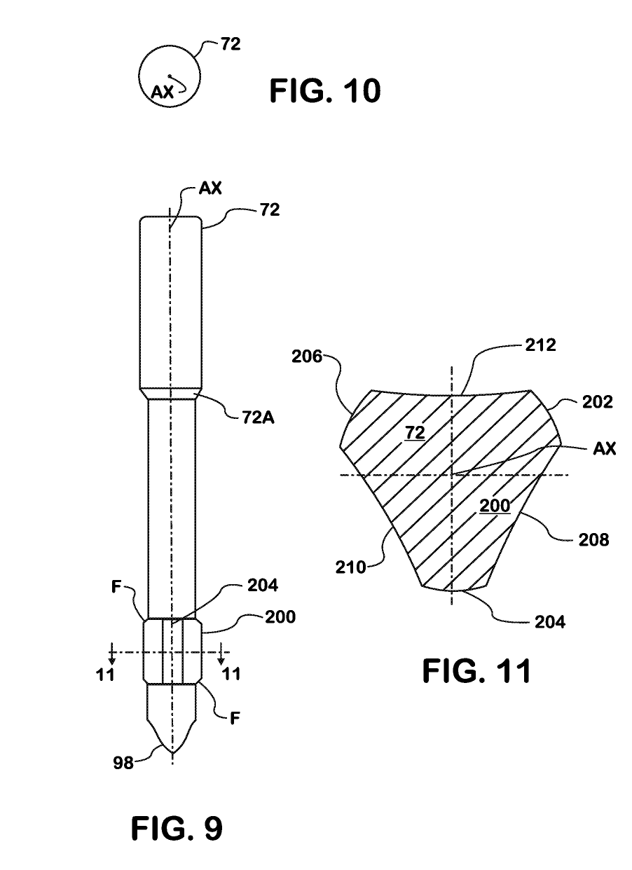

Nozzle 36 comprises a central needle guide bore 70 that is concentric with axis AX and open at the nozzle's flat proximal end face and that extends distally to tip end 34. A needle 72 (also shown by itself in FIGS. 9-11) is disposed within needle guide bore 70 and guided for displacement along axis AX. A circular cylindrical proximal portion 74 of needle guide bore 70 (see FIG. 3) guides a proximal portion of needle 72 that has a circular cylindrical shape, providing one point of axial guidance for needle 72. An intermediate portion of needle guide bore 70, to which the distal end of proximal portion 74 opens at a shoulder 76, comprises a circular sidewall 78 extending distally from shoulder 76 parallel and coaxial with axis AX and a tapering sidewall 80 that narrows distally from circular sidewall 78 to merge with a distal portion of the needle guide bore. Collectively, shoulder 76, sidewall 78, and sidewall 80 form a needle feed cavity 81.

Within the interior of tip end 34, needle guide bore 70 has a tapering surface 82 providing a seat for needle 72. The seat is a proximal boundary for a SAC volume 84 (see FIG. 4). A series of orifices 86 are distributed circumferentially around nozzle 36, extending through the nozzle wall from SAC volume 84 to the nozzle exterior. Fuel is supplied to needle feed cavity 81 through a slant passage 85. Needle 72 comprises a narrowing taper portion 72A disposed within needle feed cavity 81 to confront the intersection of slant passage 85 with shoulder 76 and sidewall 78. Axially between needle feed cavity 81 and tapering surface 82, radial clearance exists between needle 72 and needle guide bore 70 for fuel to pass from needle feed cavity 81 along the needle's length to the needle seat on the interior of tip end 34, as will be more fully explained later.

Fuel injector 30 is one of several like it that are mounted in an engine cylinder head. Fuel under pressure in a fuel supply system (not shown) serving all fuel injectors can enter main body 32 through holes 88 (see FIG. 12) that form a fuel inlet port of injector 30. Holes 88 are located axially between a proximal circular groove 90 (see FIG. 1) and a distal circular groove 92 that extend around the outside of main body 32 and that contain O-ring seals (not shown) for sealing an exterior zone of main body 32 that is exposed to fuel in the fuel supply system.

FIGS. 2 and 13 shows spring cage 42 to comprise an interior that houses a bias spring 94 for biasing needle 72 to seat a surface 98 (see FIG. 4) of needle 72 on tapering surface 82. A proximal end of bias spring 94 bears against an annular shim 101 (see FIG. 13) that in turn bears against an interior surface of a proximal end wall 100 of spring cage 42. The proximal end of a needle lift pin 106 passes with clearance through the open center of shim 101. Needle lift pin 106 has a length that is less than the axial distance between the interior surface of proximal end wall 100 and the proximal end face of needle 72 when the needle is seated for allowing only limited proximal displacement (i.e. lift) of needle 72 off the seat on tapering surface 82. A distal end of bias spring 94 bears against the outer margin of a flat proximal face of a circular disk 102 to force a flat end surface of a distally raised boss 104 at the center of a distal face of disk 102 against the flat proximal end of needle 72.

FIGS. 2 and 12 show the presence of a fuel space 108 between an outside surface of spring cage 42 and an inside surface of main body 32. Fuel space 108 is also present between the inside surface of main body 32 and an outer perimeter surface of check valve body 44. Main body 32 and cartridge body 46 are tightly fastened together, causing shoulders 38 and 40 to forcefully abut and seal nozzle 36 to main body 32, and causing the respective sealing ridges in proximal and distal end faces of check valve body 44 to forcefully abut and seal against the distal end face of cartridge body 46 and the proximal end face of wall 100 of spring cage 42 respectively. The sealing ridges create certain zones, or cavities, between respective confronting end faces, as will be more fully explained hereinafter.

Dowels 170, 172, shown in FIG. 13, provide proper circumferential location of spring cage 42, check valve body 44, and cartridge body 46 to one another by closely fitting to respective blind holes 174, 176 in spring cage 42, to respective through-holes 178, 180 in check valve body 44, and to respective blind holes 182, 184 in cartridge body 46. The dowels also assure coaxiality of spring cage 42, check valve body 44, and cartridge body 46 with axis AX.

Dowels 186, 188, shown in FIG. 2, assure coaxiality of nozzle 36 to axis AX and provide proper circumferential location of spring cage 42 to nozzle 36 by closely fitting to respective blind holes 190, 192 in spring cage 42 and to respective blind holes 194, 196 in nozzle 36.

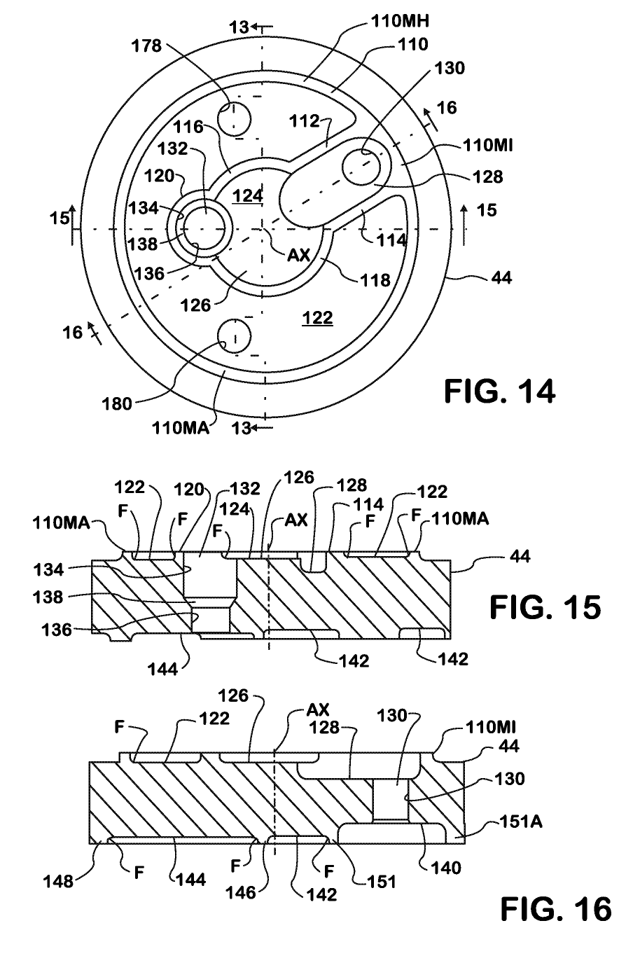

FIGS. 12-19 show detail of check valve body 44 and the respective sealing ridges at its proximal and distal end faces. The proximal end face comprises a geometry that includes an endless circular sealing ridge 110 concentric with axis AX. From a point at about the two-o'clock position shown in FIG. 14, two parallel sealing ridge segments 112, 114 emerge inward from sealing ridge 110, each spaced the same distance on either side of a radial to axis AX. At their inner ends, sealing ridge segments 112, 114 merge with sealing ridge segments 116, 118 that follow arcs of a circle centered on axis AX to merge with opposite ends of a sealing ridge segment 120 that is spaced inward of sealing ridge 110 and follows a circular arc centered at a point on a diameter of check valve body 44 spaced from axis AX toward the nine o'clock position as viewed in FIG. 14.

Sealing ridge segments 112, 114, 116, 118, 120 and a majority segment (marked 110MA) of sealing ridge 110 bound a cavity 122 having a C-shape as seen in FIG. 14. Sealing ridge segments 112, 114, 116, 118, 120 and a minority segment (marked 110MI) of sealing ridge 110 bound a central cavity 124 sealed off from, but nested within, cavity 122. The sealing ridge geometry that bounds cavities 122 and 124 is continuous (i.e. endless).

The entire sealing ridge geometry (110, 112, 114, 116, 118, 120) has a flat proximal surface lying in a plane that is perpendicular to axis AX. The sealing ridge also has opposite side surfaces that extend from opposite edges of its flat proximal surface to form sides of the respective cavities 122, 124. These sides merge with the bottom surfaces of the cavities via fillets F (FIGS. 15 and 16).

Cavity 124 has a relatively shallower expanse 126 surrounding axis AX and a relatively deeper expanse 128 that, as shown in FIG. 14, extends radially outwardly from the relatively shallower expanse 126 in the direction of the two o'clock position. Proximate a radially outer end of relatively deeper expanse 128, a through-passage 130 extends through check valve body 44 parallel to axis AX. Another through-passage 132 extends through check valve body 44 parallel to axis AX and is located relative to axis AX in a direction toward the nine o'clock position as viewed in FIG. 14. Through-passage 132 comprises a larger diameter circular portion 134 joining with a smaller diameter circular portion 136 via a tapered portion 138. The proximal end of through-passage 132 is open along a portion of its circumference to relatively shallower expanse 126 of cavity 124.

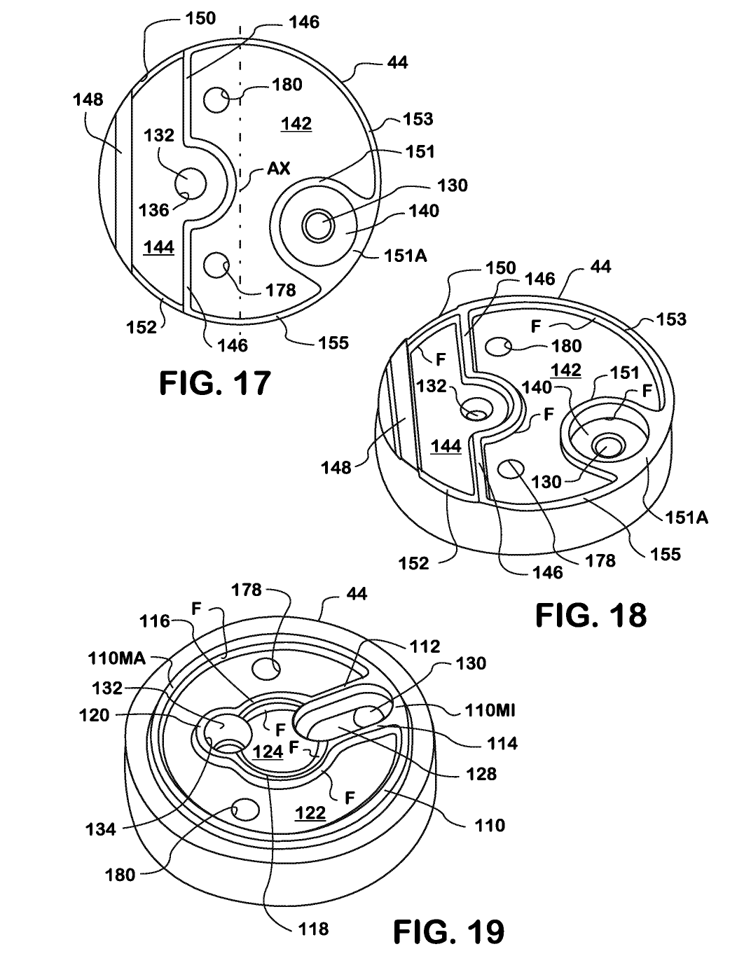

As shown by FIG. 17, the distal end face of check valve body 44 comprises a sealing ridge geometry that defines three separate cavities 140, 142, 144. Through-passage 130 is open to cavity 140 while smaller diameter portion 136 of through-passage 132 is open to cavity 144.

Sealing ridge segments 146, 148 bound sides of cavity 144, leaving reliefs 150, 152 at the cavity ends that provide for fuel in fuel space 108 to flow into cavity 144 and enter smaller diameter portion 136 of through-passage 132. Because of reliefs 150, 152, the sealing ridge that bounds cavity 144 is discontinuous.

An endless circular sealing ridge 151 bounds cavity 140, sealing the entire perimeter of that cavity so that fuel cannot enter from, or pass into, fuel space 108. Sealing ridge segments 153, 155 emerge in opposite circumferential senses from a portion 151A of sealing ridge 151 to merge with opposite ends of sealing ridge segment 146. Sealing ridge segments 153, 146, 155, and the portion of sealing ridge 151 other than portion 151A bound cavity 142 to seal the entire perimeter of that cavity so that fuel cannot enter from, or pass into, fuel space 108. The sealing ridges that bound cavities 140 and 142 are therefore continuous (i.e. endless). The sealing ridge geometry on the distal end face of check valve body 44, except where relieved, has a flat distal surface lying in a plane that is perpendicular to axis AX. Opposite side surfaces extend from opposite edges of the flat distal surface to form sides of the cavities that merge with the bottom surfaces of the cavities via fillets F (FIGS. 16 and 18).

An entry check in the form of a sphere, or ball, 154 (see FIG. 12) is disposed in larger diameter portion 134 of through-passage 132 and has a diameter smaller than that of larger diameter portion 134. Ball 154 can seat on and unseat from tapered portion 138 to close and open through-passage 132.

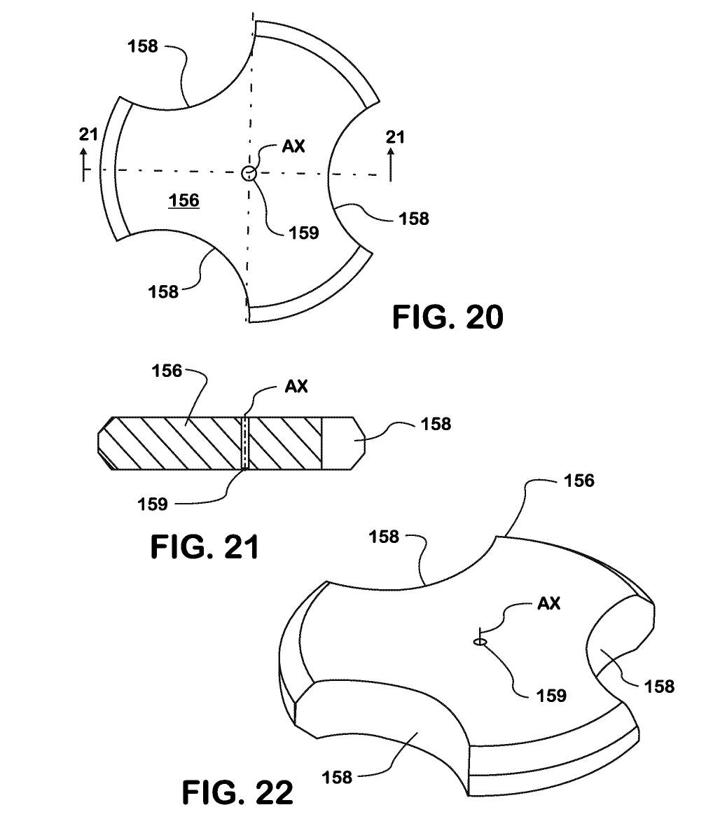

A reverse flow (exit) check 156, shown by itself in FIGS. 20-22 is disposed in cavity 140. Check 156 has flat proximal and distal end faces and would have a full circular shape except for three concave reliefs 158 symmetrically arranged in its outer margin. Check 156 can seat against the surface of check valve body 44 that forms the distally facing bottom of cavity 140 to substantially close through-passage 130, while a central through-hole 159 in check 156 provides a flow restriction whose purpose will be explained later. Check 156 can also unseat from that surface of cavity 140 to allow flow from through-passage 130 past the perimeter of reverse flow check 156 into cavity 140.

With check valve body 44 held in forced abutment with the proximal end face of spring cage 42, cavity 140 is open to a counterbore 160 in that surface of spring cage 42. Spring cage 42 comprises a fuel through-passage 162 that runs from counterbore 160 to the distal end face of the spring cage that is held in forced abutment with the proximal end face of nozzle 36. The distal end of fuel through-passage 162 aligns with the proximal end of slant passage 85 in nozzle 36.

With the sealing ridge in the proximal end face of check valve body 44 forcefully abutting the distal end face of cartridge body 46, sealing ridge segments 110MI, 112, 116, 120, 118, and 114 form an endless perimeter boundary of a zone VPZ that is bounded distally by cavity 124 and proximally by cartridge body 46. Zone VPZ is open to through-passage 132, to smaller diameter bore portion 66 of cartridge body 46, and to through-passage 130.

With the sealing ridge in the distal end face of check valve body 44 forcefully abutting the proximal end face of spring cage 92, cavity 144 provides a fuel entry zone for relatively lower pressure fuel from fuel space 108 to enter the cavity through reliefs 150, 152 and subsequently enter zone VPZ via through-passage 132 while cavity 140 provides a fuel exit zone for fuel exiting zone VPZ via through-passage 130 as will be more fully explained later.

Axial guidance of needle 72 within nozzle 36 is provided not only by proximal portion 74 of needle guide bore 70 as mentioned earlier, but also by a portion of needle guide bore 70 between tip end 34 and needle feed cavity 81. The additional guidance is enabled by endowing needle 72 with a tri-lobular formation 200 (see FIGS. 2, 9, and 11) distal to needle feed cavity 81. Formation 200 provides needle guidance while allowing fuel to pass from needle guide cavity 81 to the tip end of the nozzle interior.

FIGS. 9 and 11 show formation 200 to comprise three circumferentially spaced apart surfaces 202, 204, 206 lying on an imaginary circular cylindrical surface coaxial with axis AX. The midpoint each surface 202, 204, 206 as viewed in FIG. 11 is located 120° from the midpoints of the two other surfaces.

Concave surfaces 208, 210, 212 span and join with immediately adjacent circumferential ends of surfaces 202, 204, 206 as shown. The circumferential extent of each concave surface 208, 210, and 212 about axis AX exceeds that of each surface 202, 204, and 206 so that as a consequence, surfaces 202, 204, 206 collectively span a portion of the circumference of the circular transverse cross section of the distal portion of the needle guide bore that is less than a portion of the circumference of the circular transverse cross section of the distal portion of the needle guide bore that is spanned collectively by surfaces 208, 210, 212. Clearance that formation 200 has to the circular transverse cross section of the distal portion of needle guide bore 70 for fuel flow is provided substantially entirely by surfaces 208, 210, 212 that are concave toward the circular transverse cross section of the distal portion of the needle guide bore. The clearance provided by surfaces 208, 210, 212 provides a transverse cross sectional area for flow past formation 200 that is substantially equal to both a transverse cross sectional area provided for the fuel flow between needle 72 and the circular transverse cross section of the distal portion of needle guide bore 70 immediately proximal to formation 200 and a transverse cross sectional area provided for fuel flow between the needle and the circular transverse cross section of the distal portion of the needle guide bore immediately distal to the multi-lobular formation. It is surfaces 202, 204, 206 that have a close sliding fit to needle guide bore 70 for providing the second of the two points of axis guidance for needle 72. The small clearance of surfaces 202, 204, and 206 to the circular transverse cross section of the distal portion of the needle guide bore therefore contributes minimally, if at all, to the fuel flow area. Proximal and distal ends of formation 200 merge with circular cylindrical surface portions of needle 72 through filets F.

With structural detail of fuel injector 30 having been described, its operation can now be explained.

With valve 54 closed and fuel injector 30 having been fully charged with relatively lower pressure fuel from the relatively lower pressure fuel supply system, plunger 50 assumes a maximally refracted position as shown in FIG. 1. Fuel that has entered through holes 88 in main body 32 fills fuel space 108, cavity 144, through-passage 132, zone VPZ, and the portion of bore 47 distal to plunger 50. Reverse flow check 156 may or may not be seated against the margin of through-passage 130 in cavity 140 depending on pressure in cavity 140.

When valve 54 is actuated open, oil passes through to apply hydraulic force to piston 58, initiating distal movement of plunger 50 that begins forcing fuel out of cartridge body bore 47. Because needle 72 is seated closed on its seat in nozzle 36, the fuel from bore 47 is forced toward through-passage 132, forcing ball 154 to seat on tapered portion 138 thereby closing through-passage 132 so that fuel does not backflow from the injector. With the fuel in the injector now being essentially trapped, the hydraulic force of the oil, amplified by the ratio of the larger area of the proximal end face of piston 58 to the smaller area of the distal end face of plunger 50, greatly increases the fuel pressure in zone VPZ.

If reverse flow check 156 is not unseated from the margin of through-passage 130 in cavity 140, the greatly increased fuel pressure forces reverse flow check 156 to unseat so that the increased fuel pressure is felt along a high-pressure fuel injection flow path comprising counterbore 160, fuel passage 162, slant passage 85, and needle guide bore 70. Because of the geometry of needle 72, the pressure acts on the needle with a proximally directed force component that overcomes the distally directed force of bias spring 94, resulting in unseating of needle 72 and accompanying proximal displacement of disk 102. Continued distal displacement of plunger 50 forces fuel out of bore 47 through zone VPZ and along a path comprising through-passage 130, cavity 140, counterbore 160, fuel passage 162, slant passage 85, needle guide bore 70, and finally out of nozzle 36 through orifices 86.

Injection continues as long as plunger 50 continues to move distally. When valve 54 closes during an on-going injection, further distal displacement of plunger 50 ceases. Fuel pressure in zone VPZ quickly drops, and return spring 52 acts to return plunger 50 and piston 58 proximally toward the initial position.

The fuel pressure drop is felt along the fuel path to nozzle 36, and allows the fuel supply pressure acting through fuel space 108 and cavity 144 to unseat ball 154 and replenish the fuel injector by fuel flow from the fuel supply system through fuel supply space 108, cavity 144, through-passage 132 and zone VPZ to enter bore 47 as plunger 50 and piston 58 are being retracted by return spring 52. The pressure drop also causes reverse flow check 156 to seat against the margin of through-passage 130 so that some elevated pressure in the high-pressure fuel path from check valve body 44 to nozzle 36 is maintained as needle 72 re-seats in order to oppose entry of products of combustion in the engine cylinder through nozzle orifices 86 before needle 72 has re-seated. Through-hole 159 in reverse flow check 156 provides a restriction that allows the intensified fuel pressure to decay slowly once needle 72 has re-seated and the fuel path to nozzle 36 is substantially closed by seating of reverse flow check 156 against the margin of through-passage 130. Fuel injector 30 comprises an internal stack of only check valve body 44 and spring cage 42 forcefully held between intensifier cartridge 48 at the proximal end of main body 32 and nozzle 36 at the distal end. Consequently there are only three internal joints exposed to high pressure fuel during an injection, one between cartridge body 46 and check valve body 44, one between check valve body 44 and spring cage 42, and one between spring cage 42 and nozzle 36. The geometry of the high pressure fuel path avoids significant pressure losses in the fuel flow and avoids significant stress concentration points in the internal parts.

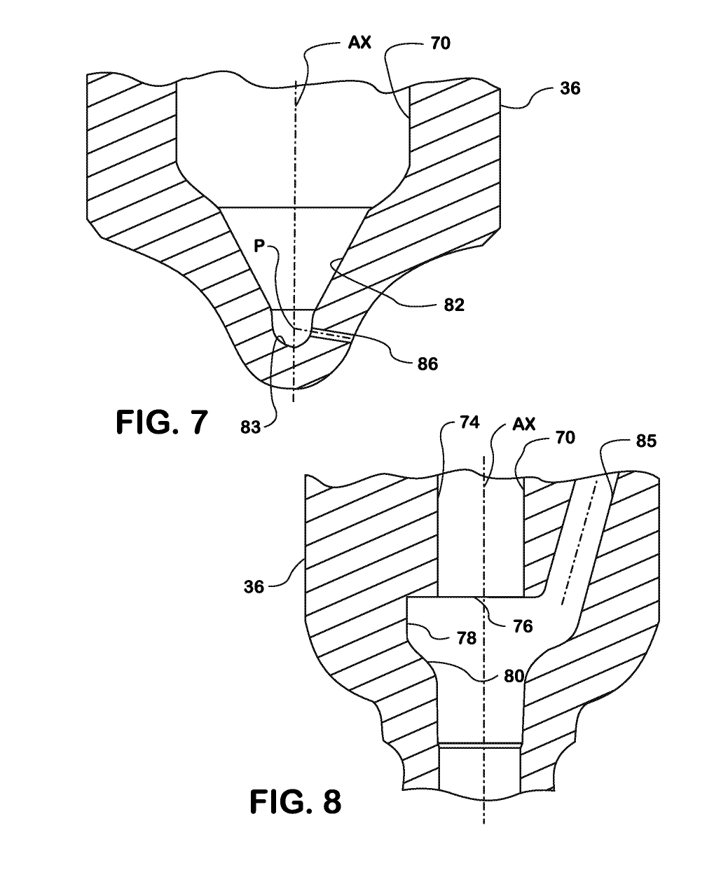

The portion of needle guide bore distal to needle feed cavity 81 has a distal end that contains, and extends axially beyond, the seat in tapering surface 82, and that contains orifices 86. FIG. 7 shows that distal end comprises a hemispherically contoured surface 83 distal to the seat. Surface 83 is centered on a point P on longitudinal axis AX. Orifices 86 have circular transverse cross sections and the axis of each orifice is arranged to extend radially of point P at an oblique angle to longitudinal axis AX. This orifice arrangement can mitigate stress concentrations in the nozzle tip.

The ‘two-point” guidance of needle 72 proximal and distal to needle feed cavity 81 promotes more uniform impacting of the needle with the needle seat on tapering surface 82, mitigating stress concentrations in the nozzle due to needle impact. The guidance can also mitigate vibration of needle 72.

Features of the disclosed construction allow fuel injector 30 to inject fuel at high pressures that can enhance the quality of combustion and engine performance.

What is claimed is:

1. A unit injector comprising:
a main body circumferentially surrounding an imaginary longitudinal axis and having an interior that is open at a proximal end;
a fuel inlet in the main body through which fuel can enter the interior of the main body;
an intensifier cartridge comprising a cartridge body that closes the open proximal end of the main body and has a distal end face disposed within the interior of the main body;
a check valve body disposed within the interior of the main body and comprising a proximal end face that confronts the distal end face of the cartridge body;
a continuous sealing ridge that seals a perimeter of a cavity between the proximal end face of the check valve body and the distal end face of the cartridge body;
an additional body comprising a proximal end face that is disposed within the interior of the main body and confronts a distal end face of the check valve body;
an entry check disposed in an entry through-passage in the check valve body and an exit check disposed in an exit through-passage in the check valve body;
a continuous sealing ridge that seals a perimeter of an exit cavity which is between the proximal end face of the additional body and the distal end face of the check valve body, and to which the exit through-passage is open;
a discontinuous sealing ridge that seals a portion of a perimeter of an entry cavity between the proximal end face of the additional body and the distal end face of the check valve body, and to which both the fuel inlet port and the entry through-passage are open;
a fuel passage from the fuel exit cavity extending through the additional body and leading to orifices from which fuel is injected from the injector;
the cartridge body comprising a bore having a distal end open to the cavity between the distal end face of the cartridge body and the proximal end face of the check valve body, and a plunger that is displaceable axially within the cartridge body bore; and
a mechanism for displacing the plunger proximally and distally within the cartridge body bore;
the plunger, when displaced proximally, being effective to unseat the entry check and draw fuel from the interior of the main body, through the entry through-passage, through the cavity between the distal end face of the cartridge body and the proximal end face of the check valve body, and into the cartridge body bore while forcing the exit check to substantially close the exit through-passage, and when displaced distally, being effective to force the entry check to close the entry through-passage, to force the exit check out of substantial closure of the exit through-passage, and to force fuel from the cartridge body bore, through the cavity between the distal end face of the cartridge body and the proximal end face of the check valve body, through the exit through-passage, through the exit cavity, and through the fuel passage from the exit cavity through the additional body.

2. A unit injector as set forth in claim 1 in which the continuous sealing ridge that seals a perimeter of an exit cavity which is between the proximal end face of the additional body and the distal end face of the check valve body is a formation in the check valve body.

3. A unit injector as set forth in claim 2 in which the continuous sealing ridge that seals a perimeter of an exit cavity which is between the proximal end face of the additional body and the distal end face of the check valve body, and to which the exit through-passage is open, and the discontinuous sealing ridge that seals a portion of a perimeter of an entry cavity between the proximal end face of the additional body and the distal end face of the check valve body, and to which both the fuel inlet port and the entry through-passage are formations in the check valve body.

4. A unit injector as set forth in claim 3 in which the main body is open at a distal end, and the orifices are contained in a nozzle that closes the open distal end of the main body and comprises a proximal end face disposed within the interior of the main body.

5. A unit injector as set forth in claim 4 in which the nozzle comprises a needle guide bore that guides a needle for axial displacement, and further including a bias spring for forcing the needle against a seat at a distal end of the needle guide bore to close a flow path through the needle guide bore to the orifices, and in which the additional body comprises a spring cage that houses the bias spring.

6. A unit injector as set forth in claim 5 in which the fuel passage from the exit cavity extends through a sidewall of the spring cage parallel to the longitudinal axis to a distal end face of the spring cage that is in abutment with the proximal end face of the nozzle, and the nozzle contains a slant passage that continues the fuel passage to the needle guide bore which continues the fuel passage to the orifices.

7. A unit injector as set forth in claim 3 in which the check valve body is coaxial with the longitudinal axis, and the entry through-passage and the exit through-passage are asymmetric with respect to the longitudinal axis.

8. A unit injector as set forth in claim 3 in which the check valve body is coaxial with the longitudinal axis, and the continuous sealing ridge that seals a perimeter of an exit cavity which is between the proximal end face of the additional body and the distal end face of the check valve body and the discontinuous sealing ridge that seals a portion of a perimeter of an entry cavity between the proximal end face of the additional body and the distal end face of the check valve body are asymmetric with respect to any diameter of the check valve body passing through the longitudinal axis.

9. A unit injector as set forth in claim 8 in which a portion of the continuous sealing ridge and a portion of the discontinuous sealing ridge define a further cavity between the entry cavity and the exit cavity.

10. A unit injector as set forth in claim 1 in which the check valve body is coaxial with the longitudinal axis, and the continuous sealing ridge that seals a perimeter of an exit cavity which is between the proximal end face of the additional body and the distal end face of the check valve body and the discontinuous sealing ridge that seals a portion of a perimeter of an entry cavity between the proximal end face of the additional body and the distal end face of the check valve body are asymmetric with respect to any diameter of the check valve body passing through the longitudinal axis.

11. A unit injector as set forth in claim 10 in which a first portion of the cavity between the proximal end face of the check valve body and the distal end face of the cartridge body has a relatively shallower expanse to which the entry through-passage is open and a second portion of the cavity between the proximal end face of the check valve body and the distal end face of the cartridge body has a relatively deeper expanse to which the exit through-passage is open.

12. A unit injector as set forth in claim 11 in which the longitudinal axis passes through the first portion of the cavity between the proximal end face of the check valve body and the distal end face of the cartridge body.

13. A unit injector as set forth in claim 12 in which the second portion of the cavity between the proximal end face of the check valve body and the distal end face of the cartridge body is symmetric about a radial to the longitudinal axis and has a radially outer end at which the exit through-passage opens.
